(19) United States
(12) Patent Application Publication
(10) Pub. No.: US 2013/0232193 A1
(43) Pub. Date: Sep. 5, 2013

(54) Control-Plane Interface Between Layers in a Multilayer Network

(71) Applicants: Zafar Ali, Hicksville, NY (US); Clarence Filsfils, Brussels (BE); Ornan Alexander Gerstel, Herzelia (IL); Jean-Philippe Vasseur, Saint Martin d'Uriage (FR); Walid Wakim, Aurora, IL (US); Matthew Hartley, Ottawa (CA); George Leonard Swallow, Boston, MA (US)

(72) Inventors: Zafar Ali, Hicksville, NY (US); Clarence Filsfils, Brussels (BE); Ornan Alexander Gerstel, Herzelia (IL); Jean-Philippe Vasseur, Saint Martin d'Uriage (FR); Walid Wakim, Aurora, IL (US); Matthew Hartley, Ottawa (CA); George Leonard Swallow, Boston, MA (US)

(21) Appl. No.: 13/783,368

(22) Filed: Mar. 3, 2013

Related U.S. Application Data
(60) Provisional application No. 61/606,459, filed on Mar. 4, 2012.

(51) Int. Cl. H04L 29/06

(52) U.S. Cl. CPC H04L 29/06047
USPC 709/203

(57) ABSTRACT

In one embodiment, information is exchanged between independent control planes of different layers in a multilayer network, such as, but not limited to, between a packet switching client-layer network and an optical server-layer network. This exchanged information includes signaling regarding a server-layer communications service, having server-layer characteristics, within the server-layer network for use in communicatively coupling at least two devices of the client-layer network. In one embodiment, the client-layer network specifies at least one of these server-layer characteristics that the server-layer communications service provided by the server-layer network must have. In one embodiment, the server-layer network signal to the client-layer network at least one of these server-layer characteristics of the existing server-layer communications service. In one embodiment, this signaling between the client-layer network and the server-layer network includes sending extended Resource Reservation Protocol (RSVP) messages.

### CROSS-REFERENCE TO RELATED APPLICATIONS

This application claims the benefit of U.S. Provisional Application No. 61/606,459, filed Mar. 4, 2012.

### TECHNICAL FIELD

The present disclosure relates generally to exchanging information between independent control planes of different layers in a multilayer network, such as, but not limited to, between a packet switching client-layer network and an optical server-layer network.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology. To communicate this information, signaling is performed in a control plane of a network to configure the data plane for properly forwarding packets.

### BRIEF DESCRIPTION OF THE DRAWINGS

The appended claims set forth the features of one or more embodiments with particularity. The embodiment(s), together with its advantages, may be best understood from the following detailed description taken in conjunction with the accompanying drawings of which:

FIG. 1A illustrates a network operating according to one embodiment;

FIG. 1B illustrates a network operating according to one embodiment;

FIG. 2A illustrates a packet switching device according to one embodiment;

FIG. 2B illustrates an apparatus according to one embodiment;

FIG. 3 illustrates a multilayer network interface according to one embodiment;

FIG. 4A illustrates a cost subobject according to one embodiment;

FIG. 4B illustrates a latency subobject according to one embodiment;

FIG. 4C illustrates a latency variation subobject according to one embodiment;

FIG. 5A illustrates an objective function subobject according to one embodiment;

FIG. 5B illustrates a metric subobject according to one embodiment;

FIG. 6A illustrates an explicit inclusion route subobject according to one embodiment;

FIG. 6B illustrates an explicit inclusion route with Shared Risk Link Groups (SRLG) subobjects according to one embodiment;

FIG. 7A illustrates a label switched path (LSP) subobject according to one embodiment; and

FIG. 7B illustrates an LSP subobject in explicit exclusion route subobject (EXRS) according to one embodiment.

### DESCRIPTION OF EXAMPLE EMBODIMENTS

### 1. Overview

Disclosed are, inter alia, methods, apparatus, computer-storage media, mechanisms, and means associated with exchanging information between independent control planes of different layers in a multilayer network, such as, but not limited to, between a packet switching client-layer network and an optical server-layer network. In one embodiment, signaling is performed between a client-layer network and a server-layer network with independent control planes in a multilayer network regarding a server-layer communications service, having server-layer characteristics including one or more particular server-layer characteristics, within the server-layer network for use in communicatively coupling at least two devices of the client-layer network.

In one embodiment, said signaling is in regards to establishing the server-layer communications service, and said signaling includes said one or more particular server-layer characteristics specified by the client-layer network that the server-layer network is to provide. One embodiment includes establishing by the server-layer network the server-layer communications service that has said one or more particular server-layer characteristics. In one embodiment, said one or more particular server-layer characteristics include an objective function, a latency requirement, a latency variation requirement, a packet loss requirement, a bandwidth requirement, one or more Shared Risk Link Groups (SRLGs) to be avoided or included, one or more inclusion routes, one or more exclusion routes, and/or one or more particular server-layer characteristics include a maximum setup time.

In one embodiment, the server-layer communications service is established and communicatively coupling said at least two devices of the client-layer network; and wherein said signaling is in regards to communicating from the server-layer network to the client-layer network said one or more particular server-layer characteristics. In one embodiment, said one or more particular server-layer characteristics include a latency in the server-layer network, a figure of merit, a cost within the server-layer network, and/or an estimated setup time of the server-layer communications service or to restore the server-layer communications service.

In one embodiment, each of said at least two devices of the client-layer network is a Layer-3 or Layer-2 packet switching device. In one embodiment, the server-layer network is an optical network. In one embodiment, said signaling between the client-layer network and the server-layer network includes sending extended Resource Reservation Protocol (RSVP) messages.

One embodiment includes a packet switching device, comprising: one or more processing elements; memory; a plurality of interfaces configured to send and receive packets within a client-layer network of a multilayer network; an optical interface configured to communicate with an optical node of an optical server-layer network of the multilayer network; and one or more packet switching mechanisms configured to switch packets among the plurality of interfaces. In one embodiment, said one or more processing elements are configured to perform operations, including: requesting, using an extension of Resource Reservation Protocol (RSVP), an optical communications path through the optical node and one or more other nodes of the optical server-layer network between the packet switching device and a second packet switching device in the client-layer network, which includes specifying one or more particular server-layer characteristics requested of the optical communications path.

One embodiment includes an optical node, comprising: one or more processing elements; memory; an optical interface configured to send and receive optical frames within an optical server-layer network of a multilayer network providing communications paths between a first and a second packet switching devices of a client-layer network of the multilayer network; and a user network optical interface configured to communicate data and signaling information with the first packet switching. In one embodiment, said one or more processing elements are configured to perform operations, including: signaling, using an extension of Resource Reservation Protocol (RSVP), one or more particular server-layer characteristics of an existing optical communications path through the optical node and one or more other nodes of the optical server-layer network between the first and the second packet switching devices.

### 2. Description

Disclosed are, inter alia, methods, apparatus, computer-storage media, mechanisms, and means associated with a control-plane interface between layers in a multilayer network. Embodiments described herein include various elements and limitations, with no one element or limitation contemplated as being a critical element or limitation. Each of the claims individually recites an aspect of the embodiment in its entirety. Moreover, some embodiments described may include, but are not limited to, inter alia, systems, networks, integrated circuit chips, embedded processors, ASICs, methods, and computer-readable media containing instructions. One or multiple systems, devices, components, etc., may comprise one or more embodiments, which may include some elements or limitations of a claim being performed by the same or different systems, devices, components, etc. A processing element may be a general processor, task-specific processor, a core of one or more processors, or other co-located, resource-sharing implementation for performing the corresponding processing. The embodiments described hereinafter embody various aspects and configurations, with the figures illustrating exemplary and non-limiting configurations. Computer-readable media and means for performing methods and processing block operations (e.g., a processor and memory or other apparatus configured to perform such operations) are disclosed and are in keeping with the extensible scope of the embodiments. The term “apparatus” is used consistently herein with its common definition of an appliance or device.

The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of reading the value, processing said read value—the value is obtained prior to processing it, although some of the associated processing may be performed prior to, concurrently with, and/or after the read operation). Also, nothing described or referenced in this document is admitted as prior art to this application unless explicitly so stated.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment includes, although an embodiment typically may include all these features, elements and/or limitations. In addition, the terms “first,” “second,” etc., are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Finally, the term “particular machine,” when recited in a method claim for performing steps, refers to a particular machine within the 35 USC §101 machine statutory class.

As used herein, a server-layer Shared Risk Link Group (SRLG) refers to a set of one or more things in the server network that will fail together, with these things being links, devices, nodes, etc. For example, an SRLG may be a device, such as a switch, repeater, regenerator, link, etc. Two links that traverse a same single point of failure (e.g., are wavelengths within a same fiber, are in different fibers that are co-located such as within a same conduit, or run under a same building such as they would both fail upon building collapse). An SRLG may also be shared between the client layer and server layer, for example, a central office that contains both optical switch and router. Further, as used herein, server-layer characteristics related to a path refer to the characteristics of the path (e.g., latency, bandwidth, Shared Risk Link Group (SRLG), cost, objective function, metric, latency variation (e.g., jitter), figure of merit, estimated setup time, inclusion or exclusion or routes, etc.) that may influence routing/forwarding decisions in a network, and server-layer characteristics do not include a source or destination address (e.g., of a node/device within a server or client network). Also, as used herein, a route refers to a set of link and node addresses.

One embodiment includes a method, comprising: signaling between a client-layer network and a server-layer network with independent control planes in a multilayer network regarding a server-layer communications service, having server-layer characteristics including one or more particular server-layer characteristics, within the server-layer network for use in communicatively coupling at least two devices of the client-layer network. In one embodiment, said signaling is in regards to establishing the server-layer communications service, and said signaling includes said one or more particular server-layer characteristics specified by the client-layer network that the server-layer network is to provide. One embodiment comprises: establishing by the server-layer network the server-layer communications service that has said one or more particular server-layer characteristics. In one embodiment, said one or more particular server-layer characteristics include an objective function. In one embodiment, said one or more particular server-layer characteristics include a latency, latency variation, packet loss, or bandwidth requirement. In one embodiment, said one or more particular server-layer characteristics include one or more Shared Risk Link Groups (SRLGs) to be avoided or included. In one embodiment, said one or more particular server-layer characteristics include one or more inclusion or exclusion routes. In one embodiment, said one or more particular server-layer characteristics include a maximum setup time. In one embodiment, said one or more particular server-layer characteristics include a label or set of labels, a type of switching to be used, or one or more Autonomous Systems (AS's).

In one embodiment, the server-layer communications service is established and communicatively coupling said at least two devices of the client-layer network; and wherein said signaling is in regards to communicating from the server-layer network to the client-layer network said one or more particular server-layer characteristics. In one embodiment, said one or more particular server-layer characteristics include a latency in the server-layer network. In one embodiment, said one or more particular server-layer characteristics include a figure of merit. In one embodiment, said one or more particular server-layer characteristics include a cost within the server-layer network. In one embodiment, said one or more particular server-layer characteristics include an estimated setup time of the server-layer communications service or to restore the server-layer communications service.

In one embodiment, each of said at least two devices of the client-layer network is a Layer-3 or Layer-2 packet switching device. In one embodiment, the server-layer network is an optical network. In one embodiment, the server-layer network is an optical network. In one embodiment, said signaling between the client-layer network and the server-layer network includes sending extended Resource Reservation Protocol (RSVP) messages.

One embodiment includes a packet switching device, comprising: one or more processing elements; memory; a plurality of interfaces configured to send and receive packets within a client-layer network of a multilayer network; an optical interface configured to communicate with an optical node of an optical server-layer network of the multilayer network; and one or more packet switching mechanisms configured to switch packets among the plurality of interfaces; wherein said one or more processing elements are configured to perform operations, including: requesting, using an extension of Resource Reservation Protocol (RSVP), an optical communications path through the optical node and one or more other nodes of the optical server-layer network between the packet switching device and a second packet switching device in the client-layer network, which includes specifying one or more particular server-layer characteristics required of the optical communications path.

One embodiment includes an optical node, comprising: one or more processing elements; memory; an optical interface configured to send and receive optical frames within an optical server-layer network of a multilayer network providing communications paths between a first and a second packet switching devices of a client-layer network of the multilayer network; and a user network optical interface configured to communicate data and signaling information with the first packet switching; wherein said one or more processing elements are configured to perform operations, including: signaling, using an extension of Resource Reservation Protocol (RSVP), one or more particular server-layer characteristics of an existing optical communications path through the optical node and one or more other nodes of the optical server-layer network between the first and the second packet switching devices.

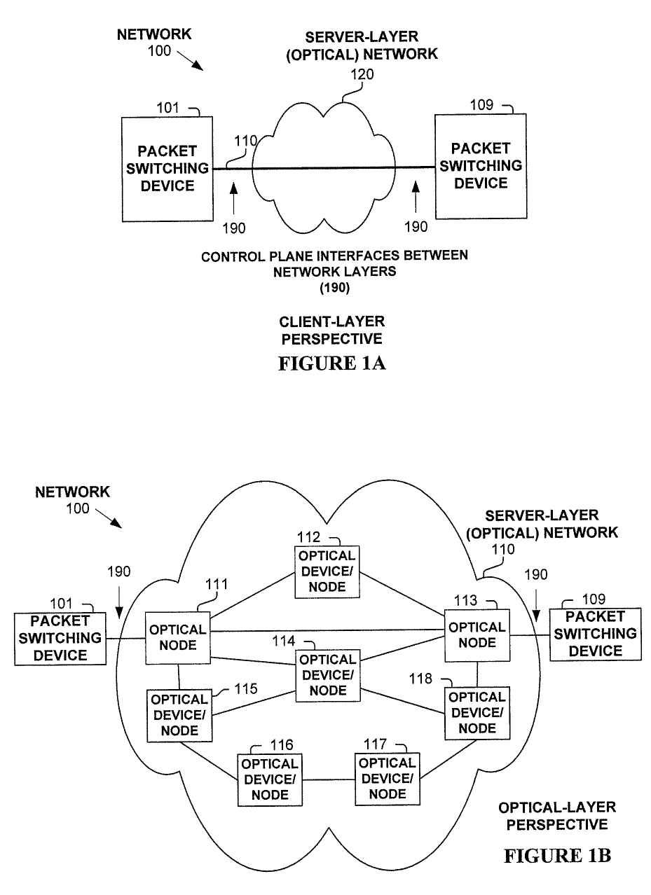

Expressly turning to the figures, FIG. 1A illustrates a network 100 including client layer devices (e.g., packet switching devices 101 and 109) and a server-layer network (e.g., optical or other network providing communications services to the client-layer devices). FIG. 1A is shown from the client-layer perspective, that is, packet switching devices 101 and 109 view that there is a client-layer path 111 between them (provided by server-network 120). Note, there is typically more than one client path through the client-layer network between packet switching devices 101 and 109, but those are not shown in FIG. 1A to allow the reader to focus on a control plane interface between the client and server layers, such as, but not limited to, in establishing an initial or replacement path through the server-layer network. The control plane of client devices 101 and 109 of the client-layer network communicate with the control plane of server-layer network 120 over control plane interfaces 190. Such a control plane interface provides for the exchange of information between independent control planes of different layers in a multilayer network, such as, but not limited to, between a packet switching client-layer network and an optical server-layer network.

FIG. 1B shows network 100 of FIG. 1A with more details about server-layer network 120 of one embodiment. As shown, server-layer (e.g., optical) network 120 includes optical nodes and devices 111-118. The use of the phrase “nodes/devices” is to indicate that some of these appliances may include a processing capability (e.g., an optical node) or an optical device (e.g., optical regenerators, cross-connects, transponders). The shown client-layer network includes packet switching devices 101-109. Server-layer network 110 includes numerous server-layer paths between client-layer devices 101 and 109. Each of these paths has server-layer characteristics of their respective capabilities, including, but not limited to, bandwidth, latency, cost, and which Shared Risk Link Groups (SRLGs) to which it belongs. One embodiment allows the control plane of client-layer network (e.g., control plane of packet switching device 101 or 109, a client-layer path computation engine, a client-layer network management system) to communicate over interfaces 190 with the control plane of a server-layer network (e.g., an optical node 111-118, a server-layer path computation engine, a server-layer network management system).

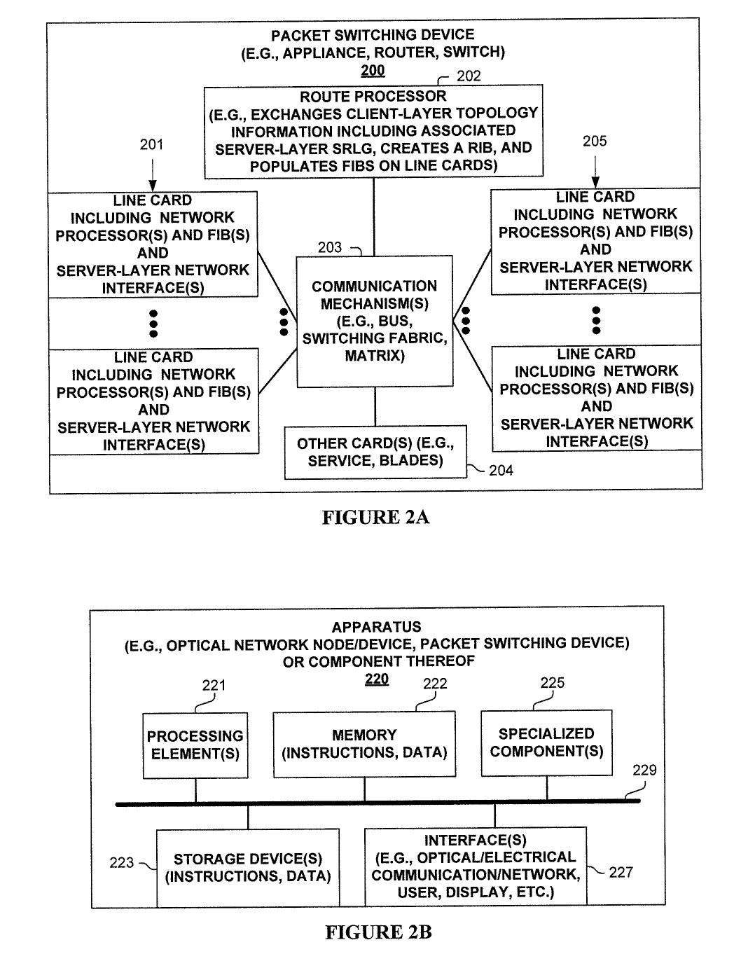

One embodiment of a packet switching device 200 is illustrated in FIG. 2A. As shown, packet switching device 200 includes multiple line cards 201 and 205, each with one or more network interfaces for sending and receiving packets over communications links (e.g., coupled to a server-layer network such as an optical network), and with one or more processing elements that are used in one embodiment associated with a control-plane interface between layers in a multilayer network. Packet switching device 200 also has a control plane with one or more processing elements 202 for managing the control plane and/or control plane processing of packets associated with a control-plane interface between layers in a multilayer network. Packet switching device 200 also includes other cards 204 (e.g., service cards, blades) which include processing elements that are used in one embodiment to process packets associated with a control-plane interface between layers in a multilayer network, and some communication mechanism 203 (e.g., bus, switching fabric, matrix) for allowing its different entities 201, 202, 204 and 205 to communicate.

FIG. 2B is a block diagram of an apparatus 220 (e.g., node, device, path computation engine, network management device) used in one embodiment associated with a control-plane interface between layers in a multilayer network. In one embodiment, apparatus 220 performs one or more processes, or portions thereof, corresponding to one of the flow diagrams illustrated or otherwise described herein, and/or illustrated in another diagram or otherwise described herein.

In one embodiment, apparatus 220 includes one or more processing element(s) 221, memory 222, storage device(s) 223, specialized component(s) 225 (e.g. optimized hardware such as for performing lookup and/or packet processing operations, etc.), and interface(s) 227 for communicating information (e.g., sending and receiving packets, user-interfaces, displaying information, etc.), which are typically communicatively coupled via one or more communications mechanisms 229, with the communications paths typically tailored to meet the needs of a particular application.

Various embodiments of apparatus 220 may include more or fewer elements. The operation of apparatus 220 is typically controlled by processing element(s) 221 using memory 222 and storage device(s) 223 to perform one or more tasks or processes. Memory 222 is one type of computer-readable/computer-storage medium, and typically comprises random access memory (RAM), read only memory (ROM), flash memory, integrated circuits, and/or other memory components. Memory 222 typically stores computer-executable instructions to be executed by processing element(s) 221 and/or data which is manipulated by processing element(s) 221 for implementing functionality in accordance with an embodiment. Storage device(s) 223 are another type of computer-readable medium, and typically comprise solid state storage media, disk drives, diskettes, networked services, tape drives, and other storage devices. Storage device(s) 223 typically store computer-executable instructions to be executed by processing element(s) 221 and/or data which is manipulated by processing element(s) 221 for implementing functionality in accordance with an embodiment.

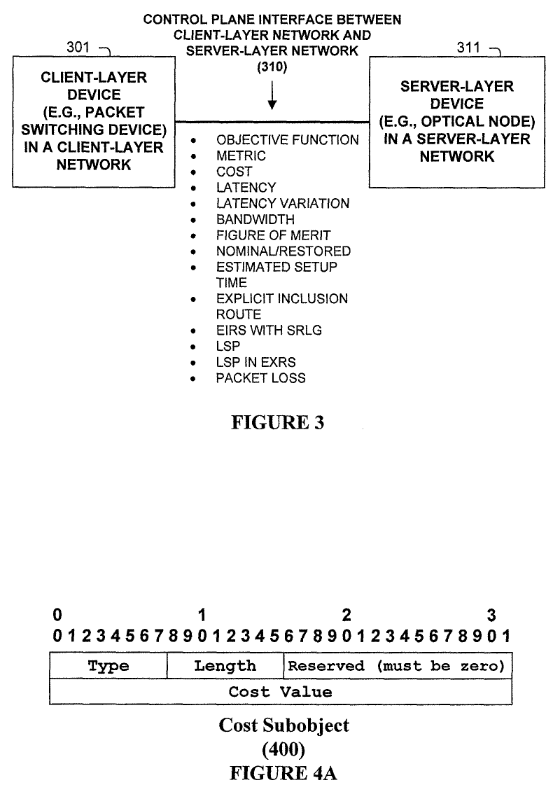

FIG. 3 illustrates a client layer device 301 (e.g., packet switching device) in a client-layer network and a server-layer device 311 (e.g., optical device) in a server-layer network. Client layer device 3011 communicates over with server-layer device 311 over the control plane interface 310. In one embodiment, there is an optical fiber or other communications link between client-layer device 301 and server-layer device 311, which typically also carries data traffic in addition to the multilayer control-plane interface (310) traffic. Control-plane information communicated over the client-layer to network-layer interface (310) in one embodiment includes, but is not limited to: objective function, metric, cost, latency, latency variation, bandwidth, figure of merit, nominal/restored, estimated setup time, explicit inclusion route, explicit inclusion route with SRLG, label switched path (LSP), and/or LSP with explicit exclusion route.

Control planes of layers in a multilayer network are often independent, and possibly not managed or owned by a same entity, and therefore do not communicate information such as via an interior gateway protocol (IGP). Also, server-layer network providers may not want the client-layer subscribers to have access to confidential information about their network, which may include how a particular path is routed.

Using multilayer control-plane interface (310), the client-layer network (301) and server-layer network (311) may exchange information which each layer needs to provide to, or receive from, the other layer. In one embodiment, extensions are provided to Resource Reservation Protocol (RSVP) to allow for the client-layer to dynamically and automatically learn the characteristics of the server-layer service (e.g., latency, latency variation (e.g., jitter), actual bandwidth, cost, figure-of-merit, restored/nominal state, packet loss and protection state), as well as to specify requirements for a service to be provided by the server-layer (e.g., objective function, metric bound, explicit inclusion routes, explicit inclusion label(s), explicit inclusion SRLG(s), explicit inclusion Autonomous System(s), explicit inclusion switching layer, exclusion routes or SRLGs, explicit exclusion label(s), explicit exclusion SRLG(s), explicit exclusion Autonomous System(s), explicit exclusion switching layer). In one embodiment, extensions to IGP and/or BGP-LS and/or RSVP-TE allow from characteristics learned via the multilayer control-plane interface (310) to be distributed throughout the client-layer network.

Hereinafter is discussed some of the characteristics received by the client-layer network (301) via control-plane interface (310) from the server-layer network (311) (and their possible use), as well as service requirements provided by the client-layer network (301) via control-plane interface (310) to the server-layer network (311).

Latency and latency variation, and possibly packet loss, plays an ever-dominant role in Service SLAs (service level agreements), as different client-layer applications may require guarantees of bandwidth, and/ or latency and/or other characteristics of transport services provided by a server-layer network. In one embodiment, it is critical for the operator of the client-layer network (e.g. IP layer) to know the latency and latency variation delivered on a per-link basis by the server-layer network (e.g. optical network), whether it is within the expected range, and the historical variations: how often, how long, how bad was the additional latency. This helps for troubleshooting and optimization. The same benefits are applicable to the other service characteristics learned through these extensions. For example, client-layer routing reaction upon link failure can vary based on the automated discovery of whether protection is offered by the server-layer network (e.g. a slower client-layer network reaction if the optical-layer network will respond quickly; otherwise the client-layer network will be configured to provide a faster reaction).

In one embodiment, the RSVP protocol is extended with new objects to allow the server layer to pass the characteristics to the client layer, on a per service basis. These characteristics include, but are not limited to, latency, latency variation (e.g., jitter), bandwidth, cost, figure of merit, restored/nominal state, packet loss and protected state. In one embodiment, once the client node discovers these properties through the RSVP-UNI extensions, these properties are distributed to the client-layer network, such as via extensions to IGP or BGP LS. In one embodiment, these acquired characteristics are recorded and analyzed, both on a historical and real-time basis, and appropriately generating warning or alarm messages, and reports.

FlexSpectrum DWDM technology allows different bandwidths to be supported by the same physical port. In one embodiment, the client-layer network can acquire from the server-layer network information about the bandwidth of a service (as it could vary over time based on reconfiguration of the server-layer network). In one embodiment, in response to a failure or other server-layer (e.g., optical) network change, bandwidth may be traded for reaching the far end-point as the optical path is now longer to avoid a failed optical resource. One embodiment allows the client-layer network to acquire this information from the server-layer network so that it can correspondingly adjust its routing/traffic engineering policy (e.g., reroute some of the flows away from the link with less capacity).

In one embodiment, the client-layer network requests the server-layer network to collect statistics of server-layer characteristics (e.g., latency, latency variation, cost) of a path through the server-layer network. In response, the server-layer network signals the corresponding server-layer nodes (e.g., sends a message that propagates hop-by-hop and collects the raw or accumulated data, sends individual requests messages to server-layer nodes). This server-layer network communicates this raw, accumulated or otherwise processed requested information to the client-layer network.

In one embodiment, the client-layer network acquires cost information from the server-layer network. For example, the cost in an optical network typically reflects considerations such as the number of reconfigurable optical add-drop multiplexer (ROADM) hops, the number of regeneration hops, the end-to-end mileage, and/or whether the fibers are owned or leased. Knowing the cost of the underlying path, one embodiment allows the client-layer network to adjust its routing/traffic-engineering policy to distribute the traffic accordingly (e.g. favoring lower-cost path if all other characters are equal). Furthermore, in the context of reoptimization of its links, the client-layer network may prefer a new path if it decreases its cost (e.g., one less regeneration point).

In one embodiment, the client-layer and server-layer networks communicate figure of merit information, especially in regards to multilayer optimization. For example in one embodiment, the server-layer network offers to the client-layer network an alternative path which does not change the server-layer characteristics of the current path (e.g., same latency, same bandwidth, same cost), but will improve the server-layer network's overall resource utilization. This helps a cooperative client-layer network to decide whether to accept changes in order to optimize the underlying (otherwise invisible) server-layer network and at the same time minimize churn resulting from such changes. For example, the client layer could compare the figure of merit of the new server layer path to the figure of merit of the currently used path and only accept the change if the difference between said figures of merit is above a predefined threshold.

In one embodiment, the client-layer network acquires nominal/restored state information from the server-layer network regarding whether a link is on the nominal path used for a service or in restored state (e.g., on a path within the server-layer network which is not the nominal/preferred path). For example, in order to avoid traffic redirection during a future reoptimization, the client layer may prefer to avoid placing premium services on a path involving restored links even if they meet the desired latency constraints.

In one embodiment, the client-layer network acquires an estimated setup time for provisioning or changing a particular service from the server-layer network, such as in, but not limited to, setting up a new label switched path (LSP) or reoptimizing an existing LSP.

In the context of an optical server-layer network, the set up time may greatly vary with the optical technology in use, the server-layer control plane characteristics, and topology (e.g., the number of regeneration hops and/or the end-to-end mileage). One embodiment uses an acquired estimated LSP set up time to decide on the frequency at which to set up new links according to a traffic matrix (e.g., it may not be useful to request a new LSP to absorb a short-lived temporary spike if the optical layer takes too long to set up the LSP). One embodiment uses an acquired estimated LSP set up time to decide whether to reoptimize an LSP if a better path can be found, even when using a non-disruptive mechanism, as reoptimizing an LSP may impact the SLA for some period of time, thus the need to know the set up time provided by the server layer). One embodiment uses acquired estimated setup times of paths through the server-layer network to decide how to reroute traffic in response to a failure based on the estimated time to repair such a link. One embodiment uses acquired estimated setup times of paths through the server-layer network to decide how to route different priorities of traffic, as higher-priority traffic may be sent over paths with a shorter restoration time. One embodiment uses acquired estimated setup times of paths through the server-layer network to protect a link that is slow to setup with a backup tunnel providing bandwidth protection; by contrast a link fast to repair in the server-layer network may be protected just using IGP recovery.

In one embodiment, the client-layer network provides a maximum tolerable setup time to the server-layer network. In one embodiment, the server-layer network will not setup an available path if the specified maximum tolerable setup time would be exceeded (e.g., estimated based on an historical database).

In one embodiment, when requesting a path through the server-layer network, the client-layer network uses an extended RSVP-UNI signaling, which consists of adding a new bit (I Bit) and optional a MAX_Time TLV. When I=1, this indicates that the client-layer network requires the server-layer network to provide some indication of the estimated set up time once the path has been successfully set up. When present, the MAX_Time TLV allows the client to indicate to the server the maximum tolerable set up time. If the server layer determines (accordingly to its historical database) that the estimated set up time is higher than MAX_Time*Delta (Delta=margin of error factor), then the server immediately sends a negative reply to the client even if a path can be found. Note that the MAX_Time allows a client server to avoid the setup of a new LSP to absorb a temporary spike of traffic in the network for example; the client may also decide not to reoptimize an LSP.

In one embodiment, the negative reply provided by the server layer may also include several indications of the max, min, average set up time, in addition to the suggested time for another attempt, should the server layer keep track of set up times according to time of the day. Additionally, the server layer may also provide the most significant delay component (e.g., signaling the LSP itself, computation time).

### A. Communication Between Client and Server Layers of Recording TE Metric of a Forwarding Adjacency (FA) and Routing Adjacency (RA)

Traffic Engineering (TE) metrics such as cost, latency and latency variation associated with a Forwarding Adjacency (FA) or Routing Adjacency (RA) Label Switched Path (LSP) are communicated between client-layer and server-layer networks. One embodiment provides extensions for the Resource Reservation Protocol-Traffic Engineering (RSVP-TE) for the support of the discovery of cost, latency and latency variation of an LSP by a client-layer network from a server-layer network, and possibly vice versa.

There are many scenarios in packet and optical networks where the route information of an LSP may not be provided to the ingress node (e.g., to the client-layer network by the server-layer network) for confidentiality reasons and/or the ingress node may not run the same routing instance as the intermediate nodes traversed by the path. In such scenarios, the ingress node cannot get the cost, latency and latency variation properties of the LSP's route. Similarly, in Generalized Multi-Protocol Label Switching (GMPLS) networks signaling bidirectional Label Switched Path (LSP), the egress node cannot get the cost, latency and latency variation properties of the LSP route. A multi-domain or multilayer network is an example of such networks. Similarly, a GMPLS User-Network Interface (UNI), such as that described in RFC 4208, is also an example of such networks.

In certain networks, such as financial information networks, network performance information (e.g. latency, latency variation) is becoming as critical to data path selection as other metrics. If cost, latency or latency variation associated with an FA or an RA LSP is not available to the ingress or egress nodes (e.g., the client-layer network), it cannot be advertised as an attribute of the FA or RA. One possible way to address this issue is to configure cost, latency and latency variation values manually. However, in the event of an LSP being rerouted (e.g. due to reoptimization), such configuration information may become invalid. Consequently, in case where an LSP is advertised as a TE-Link, the ingress and/or egress nodes cannot provide the correct latency, latency variation and cost attribute associated with the TE-Link automatically.

In summary, there is a requirement for the ingress and egress nodes (e.g., client-layer network devices) to learn the cost, latency and latency variation attributes of an FA or RA LSP. One embodiment provides extensions to the Resource Reservation Protocol-Traffic Engineering (RSVP-TE) for the support of the automatic discovery of cost, latency and latency variation attributes of an LSP by a client-layer network from a server-layer network. In one embodiment, the client-layer endpoints of the LSP indicate whether or not the cost, latency and latency variation attributes of the LSP should be collected during the signaling procedure of setting up the LSP. The server-layer endpoints of the LSP may collect the cost, latency and latency variation information and use it for routing, flooding, and TE link configuration purposes.

When the cost, latency and latency variation property of a TE link along the LSP route changes within a server-layer network, e.g., if the administrator changes cost of a TE link, the client-layer network endpoints of the LSP need to be capable of updating the cost, latency and latency variation information of the path. Similarly, if a path segment of the LSP is rerouted within the server-layer network, the client-layer network endpoints of the LSP need to be capable of updating the cost, latency and latency variation information of the path.

One embodiment provides extensions to RSVP-TE for signaling between the client and server layers of a network. In one embodiment, in order to indicate that cost collection is desired, a new flag in the Attribute Flags TLV which can be carried in an LSP₁₃ REQUIRED_ATTRIBUTES Object is used: Cost Collection flag. The Cost Collection flag is meaningful in a Path message. If the Cost Collection flag is set to 1, the transit nodes (e.g., the nodes of the server-layer network) should report the cost information to the ingress and egress nodes (e.g., the nodes of the client-layer network) in the Path Record Route Object (RRO) and the Resv RRO. The rules of the processing of the Attribute Flags TLV in one embodiment follows that described in RFC5420.

In order to indicate that latency collection is desired, a new flag in the Attribute Flags TLV which can be carried in an LSP_REQUIRED_ATTRIBUTES Object is used: Latency Collection flag. The Latency Collection flag is meaningful on a Path message. If the Latency Collection flag is set to 1, the transit nodes should report the latency information to the ingress and egress nodes in the Path RRO and the Resv RRO.

The rules of the processing of the Attribute Flags TLV in one embodiment follows that described in RFC5420.

In order to indicate that latency variation collection is desired, a new flag in the Attribute Flags TLV which can be carried in an LSP_REQUIRED_ATTRIBUTES Object is used: Latency Variation Collection flag (to be assigned by IANA, recommended bit position 11). The Latency Variation Collection flag is meaningful on a Path message. If the Latency Variation Collection flag is set to 1, the transit nodes should report the latency variation information to the ingress and egress nodes in the Path RRO and the Resv RRO. The rules of the processing of the Attribute Flags TLV in one embodiment follows that described in RFC 5420

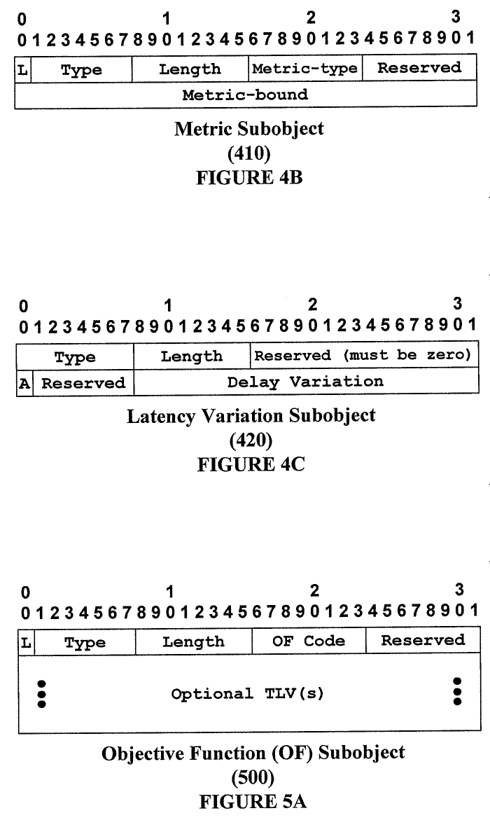

A new cost subobject 400 is defined for the RRO to record the cost information of the LSP, with its format used in one embodiment illustrated in FIG. 4A, and with the fields defined as follows.

Type: The type of the subobject, to be assigned by IANA (recommended value 35).

Length: The Length value is set to 4.

Reserved: This field is reserved for future use. It must be set to 0 when sent and must be ignored when received.

Cost Value: Cost of the link along the route of the LSP. Based on the policy at the recording node, the cost value can be set to the Interior Gateway Protocol (IGP) metric or TE metric of the link in question. This approach has been taken to avoid defining a flag for each cost type in LSP_REQUIRED_ATTRIBUTES subobject. It is assumed that, based on policy, all nodes report the same cost-type and that the ingress and egress nodes know the cost type reported in the RRO.

The rules of the processing of the LSP_REQUIRED_ATTRIBUTES Object and RRO are not changed.

A new Latency subobject 410 is defined for RRO to record the latency information of the LSP, with its format used in one embodiment illustrated in FIG. 4B, and with the fields defined as follows.

Type: The type of the subobject, to be assigned by IANA (recommended value 36).

Length: The Length value is set to 4.

A-bit: This field represents the Anomalous (A) bit.

Reserved: These fields are reserved for future use. They must be set to 0 when sent and must be ignored when received.

Delay Value: This 24-bit field carries the average link delay over a configurable interval in micro-seconds, encoded as an integer value. When set to 0, it has not been measured. When set to the maximum value 16,777,215 (16.777215 sec), then the delay is at least that value and may be larger.

The rules of the processing of the LSP_REQUIRED_ATTRIBUTES Object and RRO are not changed.

A new Latency Variation subobject 420 is defined for RRO to record the Latency information of the LSP, with its format used in one embodiment illustrated in FIG. 4C, and with the fields defined as follows.

Type: The type of the subobject, to be assigned by IANA (recommended value 37).

Length: The Length value is set to 4.

A-bit: This field represents the Anomalous (A) bit.

Reserved: These fields are reserved for future use. It must be set to 0 when sent and must be ignored when received.

Delay Variation Value: This 24-bit field carries the average link delay variation over a configurable interval in micro-seconds, encoded as an integer value. When set to 0, it has not been measured. When set to the maximum value 16,777,215 (16.777215 sec), then the delay is at least that value and may be larger.

The rules of the processing of the LSP_REQUIRED_ATTRIBUTES Object and RRO are not changed.

Typically, the ingress node learns the route of an LSP by adding a RRO in the Path message. If an ingress node also desires cost, latency or latency variation recording, it sets the Cost Collection flag, Latency Collection flag or Latency Variation Collection flag in the Attribute Flags TLV of LSP_REQUIRED_ATTRIBUTES Object, respectively. None, all or any of the Cost Collection, Latency Collection or Latency Variation Collection flags may be set in the Attribute Flags TLV of LSP_REQUIRED_ATTRIBUTES Object.

When a node receives a Path message which carries an LSP_REQUIRED_ATTRIBUTES Object and the Cost, Latency or/and Latency Variation Collection Flag(s) is (are) set, if local policy disallows providing the requested information to the endpoints, the node should return a Path Error message to reject the Path message. Otherwise, it must add the requested subobject(s) with the cost, latency or/and latency variation metric value(s) associated with the local hop to the Path RRO. Then it forwards the Path message to the next node in the downstream direction.

Following the steps described above, the intermediate nodes of the LSP provide the requested metric value(s) associated with the local hop in the Path RRO. When the Path message is received by the egress node, the egress node can calculate end-to-end the cost, latency or/and latency variation properties of the LSP.

Before the Resv message is sent to the upstream node, the egress node must add the requested subobject(s) with the cost, latency or/and latency variation metric value(s) associated with the local hop to the Resv RRO. Similarly, the intermediate nodes of the LSP provide the requested metric value(s) associated with the local hop in the Resv RRO. When the Resv message is received by the Ingress node, the Ingress node can calculate end-to-end the cost, latency or/and latency variation properties of the LSP.

Typically, cost and latency are additive metrics, but latency variation is not additive metric. How the egress node computes the end-to-end cost, latency or/and latency variation metric from information recorded in the RRO is beyond the scope of this section.

Based on the local policy, the ingress and egress nodes can advertise the end-to-end the cost, latency or/and latency variation properties of the FA/RA LSP in TE link advertisement to the routing instance.

Based on the local policy, a transit node (e.g. the edge node of a domain) may edit the RRO to remove the route information (e.g. node, interface identifier information) before forwarding it and can summarize the cost, latency or/and latency variation as a single number for the loose hop that is summarized by the edge node.

### B. Communication Between Client and Server Layers of Objective Function and/or Metric Bound

In one embodiment, a client-layer network communicates an objective function and/or metric bound to a server-layer network for use by the server-layer network in determining how to provide network services to the client-layer network. These server-layer characteristics can be used by the control plane of the server-network in determining which of multiple paths through the server network is most appropriate for the desired application. In one application, bandwidth may be more important, while in another application, minimizing end-to-end latency might be the most important criteria for path selection through the server-layer network. Even if bandwidth is the most important criteria, there may be a maximum acceptable latency bound constraint on paths through the server-layer network.

In one embodiment, the control interface between different layers of a multilayer network includes extensions to Resource Reservation Protocol—Traffic Engineering (RSVP-TE) to communicate a requested objective function and/or a metric bound from the client-layer network to the server-layer network, such as, but not limited to, for use by the server-layer network in making route computation decisions. In one embodiment, two new Explicit Route Object (ERO) subobject types are used: Objective Function (OF) and Metric. In one embodiment, OF subobject conveys a set of one or more specific optimization criteria that must be followed in expanding the route of an MPLS-TE label switched path (TE-LSP) in MultiProtocol Label Switching (MPLS) and Generic MultiProtocol Label Switching (GMPLS) networks. In one embodiment, metric subobject indicates the bound on the path metric that must not be exceeded for the loose segment to be considered as acceptable by the ingress node. The scope of the Metric and OF subobjects is the node performing the expansion for loose ERO and the subsequent ERO subobject that identifies an abstract node.

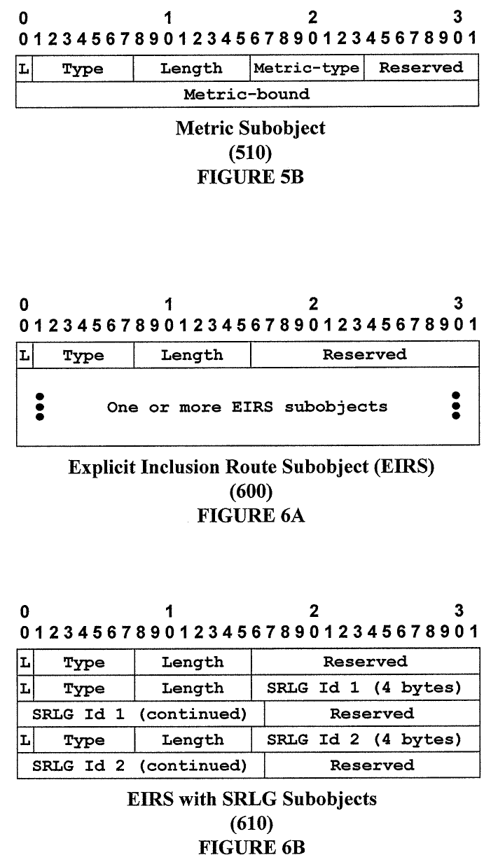

A new ERO subobject type Objective Function (OF) is defined in order for the ingress node (e.g., client-layer device) to indicate the used objective function on a loose hop. The ERO subobject type OF is optional. It may be carried within an ERO object of RSVP-TE Path message. The format of one embodiment's OF subobject 500 is illustrated in FIG. 5A, with the fields of OF subobject defined as follows.

L bit: The L bit should be set, so that the subobject represents a loose hop in the explicit route.

Type: The Type is to be assigned by IANA (suggested value: 66).

Length: The Length is 12.

OF Code (1 byte): The identifier of the objective function. The following OF code values are suggested. These values are to be assigned by IANA.
0) OF code value 0 is reserved.
1) OF code value 1 (to be assigned by IANA) is for Minimum Cost Path (MCP) OF as defined in RFC5541.

1 2) OF code value 2 (to be assigned by IANA) is for Minimum Load Path (MLP) OF as defined in RFC5541.
3) OF code value 3 (to be assigned by IANA) is for Maximum Residual Bandwidth Path (MBP) OF as defined in RFC5541.
4) OF code value 4 (to be assigned by IANA) is for Minimize Aggregate Bandwidth Consumption (MBC) OF as defined in RFC5541.
5) OF code value 5 (to be assigned by IANA) is for Minimize the Load of the most loaded Link (MLL) OF as defined in RFC5541.
6) OF code value 6 is skipped (to keep the objective function code values consistent between RFC 5541 and this draft.
7) OF code value 7 (to be assigned by IANA) is for Minimum Latency Path (MLP) OF defined in this section. See definition of MLP OF in the following.
8) OF code value 8 (to be assigned by IANA) is for Minimum Latency Variation Path (MLVP) OF defined in the following.

Other objective functions are used in one embodiment, such as, but not limited to specifying a minimum required bandwidth.

Reserved (1 byte): This field must be set to zero on transmission and must be ignored on receipt.

Optional TLVs are used in one embodiment to encode objective function parameters.

A Minimum Latency Path (MLP) OF is defined as an Objective Function where a path is computed such that latency of the path is minimized. In one embodiment and in the context of loose hop expansion, the ERO expanding node must try to find a route such that overall latency of the loose hop is minimize.

A Minimum Latency Path (MLP) OF is defined as an Objective Function where a path is computed such that latency variation in the path is minimized. In one embodiment and in the context of loose hop expansion, the ERO expanding node must try to find a route such that overall latency variation of the loose hop is minimized.

A Metric Subobject is used in one embodiment. The ERO subobject type Metric is optional. It may be carried within an ERO object of RSVP-TE Path message. This metric subobject 510 used in one embodiment has the format illustrated in FIG. 5B. The fields of the Metric subobject used in one embodiment are defined as follows:

L bit: The L bit should be set, so that the subobject represents a loose hop in the explicit route.

Type: The Type is to be assigned by IANA (suggested value: 67).

Length: The Length is 12.

Metric-type (8 bits): Specifies the metric type associated with the partial route expended by the node processing the loose ERO. The following values are currently defined for use in one embodiment:
T=1: cumulative IGP cost
T=2: cumulative TE cost
T=3: Hop Counts
T=4: Cumulative Latency
T=5: Cumulative Latency Variation

Reserved: This field must be set to zero on transmission and must be ignored on receipt.

Metric-bound (32 bits): The metric-bound indicates an upper bound for the path metric that must not be exceeded for the ERO expending node to consider the computed path as acceptable. The metric bound is encoded in 32 bits using IEEE floating point format.

In one embodiment, the basic processing rules of an ERO are not altered from those described in RFC 3209. The scope of the OF subobject is the previous ERO subobject that identifies an abstract node, and the subsequent ERO subobject that identifies an abstract node. Multiple OF subobjects may be present between any pair of abstract nodes. In one embodiment, the following conditions should result in Path Error with error code “Routing Problem” and error subcode “Bad EXPLICIT_ROUTE object”:

If the first OF subobject is not preceded by a subobject identifying the next hop.

If the OF subobject follows a subobject that does not have the L-bit set.

If the processing node does not understand the OF subobject, it should send a PathErr with the error code “Routing Error” and error value of “Bad Explicit Route Object” toward the sender. If the processing node understands the OF subobject and the ERO passes the above mentioned sanity check and any other sanity checks associated with other ERO subobjects local to the node, the node takes the following actions in one embodiment:

If the node supports the requested OF(s), the node expands the loose hop using the requested Objective Function(s) as minimization criterion (criteria) for computing the route to the next abstract node. After processing, the OF subobjects are removed from the ERO. The rest of the steps for the loose ERO processing follow procedures outlined in RFC 3209.

If the node understands the OF subobject but does not support any or all of the requested OF(s), it should send a Path Error with error code “Routing Problem” and a new error subcode “Unsupported Objective Function”. The error subcode “Unsupported Objective Function” for Path Error code “Routing Problem” is to be assigned by IANA (Suggested Value: 107).

If the node understands the OF subobject and supports all of the requested OF(s) but cannot perform route computation with all objective functions considered together as optimization criteria for the path computation, it should send a Path Error with error code “Routing Problem” and a new error subcode “Objective Function too complex”. The error subcode “Objective Function too complex” for Path Error code “Routing Problem” is to be assigned by IANA (Suggested Value: 108).

If the objective function is supported but policy does not permit applying it, the processing node should send a Path Error with error code “Policy control failure” (value 2) and subcode “objective function not allowed”. The error subcode “objective function not allowed” for Path Error code “Policy control failure” is to be assigned by IANA (Suggested Value: 105).

In one embodiment, the basic processing rules of an ERO are not altered from those described in RFC 3209. The scope of the Metric subobject is between the previous ERO subobject that identifies an abstract node, and the subsequent ERO subobject that identifies an abstract node. Multiple Metric subobjects may be present between any pair of abstract nodes. The following conditions should result in Path Error with error code “Routing Problem” and error subcode “Bad EXPLICIT_ROUTE object”:

If the first Metric subobject is not preceded by a subobject identifying the next hop.

If the Metric subobject follows a subobject that does not have the L-bit set.

If the processing node does not understand the Metric subobject, it should send a PathErr with the error code “Routing Error” and error value of “Bad Explicit Route Object” toward the sender. If the processing node understands the Metric subobject and the ERO passes the above mentioned sanity check and any other sanity checks associated with other ERO subobjects local to the node, the node takes the following actions in one embodiment:

For all the Metric subobject(s), the node expands the loose hop such that the requested metric bound(s) are met for the route between the two abstract nodes in the ERO. After processing, the Metric subobjects are removed from the ERO. The rest of the steps for the loose ERO processing follow the procedure outlined in RFC 3209.

If the node understands the Metric subobject but cannot find a route to the next abstract node such that the requested metric bound(s) can be satisfied, it should send a Path Error with error code “Routing Problem” and a new error subcode “No route available toward destination with the requested metric bounds”. The error subcode “No route available toward destination with the requested metric bounds” for Path Error code “Routing Problem” is to be assigned by IANA (Suggested Value: 109).

In one embodiment, objective functions are formulated using the following terminology:
A network comprises a set of N links {Li, (i=1 . . . N)}.
A path P is a list of K links {Lpi,(i=1 . . . K)}.
Metric of link L is denoted M(L). This can be the IGP metric, the TE metric, or any other metric.
The cost of a path P is denoted C(P), where C(P)=sum {M(Lpi), (i=1 . . . K)}.
Residual bandwidth on link L is denoted r(L).
Maximum reservable bandwidth on link L is denoted R(L).
   For example, in one embodiment the following three objective functions apply to the computation of a single path:
Objective Function Code: 1
Name: Minimum Cost Path (MCP)
Description: Find a path P such that C(P) is minimized.
Objective Function Code: 2
Name: Minimum Load Path (MLP)
Description: Find a path P such that
   (Max {(R(Lpi)−r(Lpi))/R(Lpi), i=1 . . . K}) is minimized.
Objective Function Code: 3
Name: Maximum residual Bandwidth Path (MBP)
Description: Find a path P such that
   (Min {r(Lpi), i=1 . . . K}) is maximized.
      For example, in one embodiment the following three objective functions that apply to a set of path computation requests the computation of which is synchronized:
Objective Function Code: 4
Name: Minimize aggregate Bandwidth Consumption (MBC)
Description: Find a set of paths such that
   (Sum {R(Li)−r(Li), i=1 . . . N})is minimized.
Objective Function Code: 5
Name: Minimize the Load of the most loaded Link (MLL)
Description: Find a set of paths such that
   (Max {(R(Li)−r(Li))/R(Li), i=1 . . . N}) is minimized.
Objective Function Code: 6
Name: Minimize the Cumulative Cost of a set of paths (MCC)
Description: Find a set of paths {P1 . . . Pm} such that
(Sum {C(Pi), i=1 . . . m}) is minimized.

### C. Communication Between Client and Server Layers for Inclusion of Routes

There are scenarios in which it is required that two or more LSPs or segments of LSPs follow the same route in the network. One embodiment communicates route inclusions along the loose hops during path setup using extensions to the Resource ReserVation Protocol-Traffic Engineering (RSVP-TE) protocol.

The RSVP-TE specification, “RSVP-TE: Extensions to RSVP for LSP Tunnels” (RFC 3209) and GMPLS extensions to RSVP-TE, “Generalized Multi-Protocol Label Switching (GMPLS) Signaling Resource Reservation Protocol-Traffic Engineering (RSVP-TE) Extensions” (RFC 3473) allow abstract nodes and resources to be explicitly included in a path setup. However, such inclusion may not be possible when a loose hop is expanded. It is obviously possible to divide the loose hop into multiple loose hops and construct an inclusion in that fashion. However, there are scenarios where division of a loose hop into multiple explicit loose hops is not possible, including but not limited to the following:

The ingress node (e.g., client-layer network) requires specific Shared Risk Link Groups (SRLGs) to be included when a loose hop is expanded.

When Ingress like certain SRLGs to be explicitly “included” when loose hop is extended. This section defines inclusion use of the SRLG subobject defined in RFC 4874.

The ingress node lacks sufficient knowledge of the topology along the loose hop to be able to divide a loose hop into a proper sequence of multiple explicit loose or strict hops.

The ingress node requires that two Label Switched Paths (LSPs) follow the same route but have no knowledge of how a loose hop of a reference LSP was expanded. There are scenarios in which it is required that two or more LSPs follows same route in the network. E.g., in many deployments it is required that member LSPs of a bundle/aggregated link (or Forwarding Adjacency (FA))) follow the same route. Possible reasons for two or more LSPs to follow the same end-to-end or partial route include, but are not limited to:
Fate sharing: it is sometimes required that two or more LSP fail together. In the example of bundle link this would mean that if one component goes down, the entire bundle goes down.
Homogeneous Attributes: it is often required that two or more LSPs have the same TE metrics like latency, delay variation, etc. In the example of a bundle/aggregated link this would meet the requirement that all component links (FAs) of a bundle should have same latency and delay variation. In certain networks, such as financial information networks, network performance (e.g. latency and latency variation) is becoming critical and hence having bundles with component links (FAs) with homogeneous delay and delay variation is important.

When the entire route of LSPs that need to follow the same route is computed by the ingress node, the aforementioned requirements can be met by a local decision at the ingress node. However, there are scenarios when a route computation is not performed at the ingress and instead are performed by remote nodes, in which case there is a need for relevant affinity requirements to be communicated to the route expanding nodes. These include (but are not limited to):

LSPs with loose hops in the Explicit Route Object (ERO), e.g. inter-domain LSPs.
Generalized Multi-Protocol Label Switching (GMPLS) User-Network Interface (UNI) where route computation may be performed by the UNI-Network (server) node;
   One embodiment allows a client-layer network to signal to the server-layer network LSPs such that the entire LSP or segments of LSP follow the same route.

One embodiment defines a new ERO subobject type the Explicit Inclusion Route Subobject (EIRS) is introduced to indicate an inclusion between a pair of included abstract nodes. The Explicit Inclusion Route Subobject (EIRS) defines abstract nodes or resources (such as links, SRLG, Circuit IDs, unnumbered interfaces, or labels, etc.) that must or should be used on the path between two inclusive abstract nodes or resources in the explicit route. An EIRS is an ERO subobject that contains one or more subobjects of its own, called EIRS subobjects. Each EIRS may carry multiple inclusions. The inclusion is encoded exactly as for XRO subobjects and prefixed by an additional Type and Length.

The new EIRS 600 is defined, with its format used in one embodiment illustrated in FIG. 6A. An example of EIRS for SRLG inclusion 610 (SRLG Id 1 and SRLG Id 2) is illustrated in FIG. 6B. This example of and EIRS its use is referenced in the following description.

There are two or more “L bits” in an EIRS. The following convention is used to reference the individual “L bits”.
EIRS.L: EIRS.L refers to the L bit of the header of the EIRS subobject. E.g., EIRS.L refers to the first L bit in EIRS example in FIG. 6B.
EIRS.SubobjectN.L: EIRS.SubobjectN.L refers to the L bit of the nth subobject of EIRS. E.g., EIRS.Subobject2.L refers to the third L bit in EIRS example in FIG. 1 (i.e., the L bit to define the expected treatment of SRLG ID2 value).
   The fields of the EIRS subobject are defined as follows:
EIRS.L bit: The L bit is an attribute of the EIRS subobject. The L bit should be set, so that the subobject represents a loose hop in the explicit route.
EIRS.T e: The type of the subobject is to be defined by IANA (Suggested Value: 68).
EIRS.Reserved: This field is reserved. It should be set to zero on transmission and must be ignored on receipt.
EIRS subobjects: An EIRS subobject indicates the abstract node or resource to be included in the path. The format of an EIRS subobject is exactly the same as the format of a subobject in the eXclude Route Object (XRO). This is with the exception of the interpretation of the “EIRS.SubobjectN.L bit” of the subobjects, as detailed in the following. EIRS.SubobjectN.L bit: For all supported subobjects of EIRS, the EIRS.SubobjectN.L bit has the following interpretation.
EIRS.SubobjectN.L=0 indicates that the attribute specified must be included.
EIRS.SubobjectN.L=1 indicates that the attribute specified should be included.

An EIRS may include all subobjects defined in this section for the XRO.

Specifically, an EIRS may include the following subobjects:
EIRS.SubobjectN.Type=1: IPv4 address.
EIRS.SubobjectN.Type=2: IPv6 address.
EIRS.SubobjectN.Type=3: Label.
EIRS.SubobjectN.Type=4: Unnumbered Interface ID.
EIRS.SubobjectN.Type=32: Autonomous system number.
EIRS.SubobjectN.Type=34: SRLG.
EIRS.SubobjectN.Type=35: Switching Capability (SC).
EIRS.SubobjectN.Type=TBD (suggested value 37): LSP

The scope of the exclusion is the previous ERO subobject that identifies an abstract node, and the subsequent ERO subobject that identifies an abstract node. The processing rules of the EIRS are the same as the processing rule of the EXRS, with the exception that EIRS subobjects request resource inclusion, whereas EXRS subobjects request resource exclusion.

Multiple inclusions may be present between any pair of abstract nodes. An EIRS may be present when an EXRS is also present in the ERO and/or an XRO is also present in the path message. Section 2.3 discusses details of processing of the EIRS with the XRO object and the EXRS subobject of ERO.

If the processing node does not understand the EIRS subobject, it behaves as described in RFC 3209 when an unrecognized ERO subobject is encountered. This means that this node will return a PathErr with error code “Routing Error” and error value “Bad EXPLICIT_ROUTE object” with the EXPLICIT_ROUTE object included, truncated (on the left) to the offending EIRS subobject.

If the following conditions are encountered, the processing node should generate a Path Error with error code “Routing Problem” and error subcode “Bad EXPLICIT_ROUTE object”:

EIRS.L bit is not set.

The EIRS subobject follows a subobject that has the L-bit not set.

If the processing node understands the EIRS subobject and all the subobjects contained in the EIRS, it takes the following steps:

For all subobjects contained in the EIRS such that EIRS.SubobjectN.L=0, the processing node finds a path that must include the resource attribute identified by the EIRS.SubobjectN.

For all subobjects contained in the EIRS such that EIRS.SubobjectN.L=1, the processing node finds a path that must include the resource attribute identified by the EIRS.SubobjectN.

If the processing node fails to find a route such that the all resources identified in the EIRS.SubobjectN for all N can be included in the route (depending on EIRS.SubobjectN.L bit setting), the node should return a PathErr with the error code “Routing Problem” and error value “Route Blocked by Include Route”. The error subcode “Route Blocked by Include Route” for Path Error code “Routing Problem” is to be assigned by IANA (Suggested Value: 110).

If the processing node understands the EIRS subobject but does not understand or support a subobject contained in the EIRS (say EIRS. SubobjectN), it should return a PathErr with error code “Routing Error” and error value “Bad EXPLICIT_ROUTE object” with the EXPLICIT_ROUTE object included, truncated (on the left) to the EIRS subobject containing the unsupported EIRS.subobjectN.

A node may reject a Path message if the EIRS is too large or complicated for the local implementation or as governed by local policy. In this case, the node should send a PathErr message with the error code “Routing Error” and error subcode “EIRS Too Complex”. An ingress LSR receiving this error code/subcode combination may reduce the complexity of the EIRS. The error subcode “EIRS Too Complex” for Path Error code “Routing Problem” is to be assigned by IANA (Suggested Value: 111).

A node performing ERO expansion may find an XRO in the Path message and both EIRS and EXRS subobjects in ERO. In this case, the processing node must include all resources identified in the EIRS and exclude all resources identified in the EXRS and XRO. If the constraints identified by the EIRS, EXRS and XRO conflict each other, the processing node should send a PathErr message with the error code “Routing Error” and error subcode “inconsistent include/ exclude constraints”. The error subcode “inconsistent include/ exclude constraints” for Path Error code “Routing Problem” is to be assigned by IANA (Suggested Value: 112).

### D. Communication Between Client and Server Layers for Exclusion of Routes

Label-Switched Path (LSP) diversity is required to ensure LSPs may be established without sharing resources, thus greatly reducing the probability of simultaneous connection failures.

LSP diversity is a well-known requirement from Service Providers. When route computation for LSPs that need to be diverse is performed at an ingress node, this requirement can be met by a local decision at that node. However, there are scenarios when route computations are performed by remote nodes, in which case there is a need for relevant diversity requirements to be communicated to those nodes. These include (but are not limited to):

LSPs with loose hops in the Explicit Route Object (ERO), e.g. inter-domain LSPs.

Generalized Multi-Protocol Label Switching (GMPLS) User-Network Interface (UNI) where route computation may be performed by the UNI-Network (server) node;

The eXclude Route Object (XRO) and Explicit Exclusion Route Subobject (EXRS) specification in RFC 4894 introduces a means of specifying nodes and resources to be excluded from routes, using the XRO and/or EXRS. RFC 4874 facilitates the calculation of diverse routes for LSPs based on known properties of those LSPs including addresses of links and nodes traversed, and Shared Risk Link Groups (SRLGs) of traversed links. This requires that these properties of the LSP(s) from which diversity is required to be known to the ingress node which initiates signaling. However, there are circumstances under which this may not be possible or desirable, including, but not limited to:
Exclusion of the route of an LSP which does not originate, terminate or traverse the ingress node signaling the diverse LSP, in which case the addresses and SRLGs of the LSP from which diversity is required are unknown to the ingress node.

Exclusion of the route of an LSP which, while known at the ingress node of the diverse LSP, has incomplete or unavailable route information, e.g. due to confidentiality of the LSP route attributes. In other words, the scenario in which the reference LSP is hosted by the ingress/requesting node but the properties required to construct an XRO object are not known to ingress/requesting node. Inter-domain and GMPLS overlay networks may present such restrictions.

If the route of the reference LSP from which diversity is required (e.g. LSP1) is known to the ingress node, that node can use this information to construct an XRO and send it in the path message during the signaling of a diverse LSP (LSP2). However, if the route of LSP1 changes (e.g. due to reoptimization or failure in the network), the ingress node would need to change path of LSP2 to ensure that it remains diverse from LSP1. It is preferable to have this decision made by the node that calculated the path for LSP2. For example, in the case of GMPLS-UNI, it is better to have such responsibility at the server layer as opposed to at the client layer so that the diversity requirements are transparent to the client layer. Furthermore, in all networking scenarios, if the node performing the route computation/expansion is aware of the diversity requirements of LSP1 and LSP2, it may consider joint re-optimization of the diverse LSPs.

This section addresses such scenarios and defines procedures that may be used to exclude the route taken by a particular LSP, or the route taken by all LSPs belonging to a single tunnel. Note that this diversity requirement is different from the diversity requirements of path protection where both the reference and diverse LSPs belong to the same tunnel. The diversity requirements considered in this section do not require that the LSPs in question belonging to the same tunnel or share an ingress node.

The means by which the node calculating or expending the route of the signaled LSP discovers the route of the LSPs from which the signaled LSP requires diversity is beyond the scope of this section. However, in most cases the LSPs with route diversity requirements may transit the node expanding the route.

This section describes the signaling extensions used in one embodiment to address the aforementioned requirements. Specifically, this section defines a new LSP subobject to be signaled in the EXCLUDE_ROUTE object (XRO) and/or Explicit Exclusion Route Subobject (EXRS) defined in RFC 4874.

As used herein, the following terminology is adapted:

CircuitID: The term CircuitID refers to the LSP FEC (LSP ID field of the FEC may be ignored depending on the context the CircuitID term is used).

LSP1/TUNNEL1: LSP1/TUNNEL1 is the LSP/tunnel from which diversity is required.

LSP2/TUNNEL2: The term LSP2/TUNNEL2 is used to refer to the LSP being signaled with XRO/EXRS containing the LSP subobject referencing LSP1/TUNNEL 1.

CircuitIDx: CicuitIDx terms are used to refer to LSPx/TUNNELx.

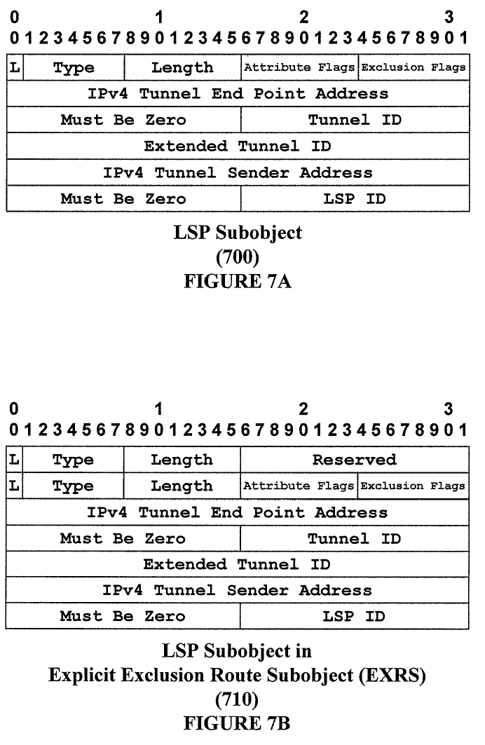

A new IPv4 P2P LSP subobject 700 is defined, with its format used in one embodiment illustrated in FIG. 7A, and with the fields defined as follows.

L. The L-flag is used as for the other XRO subobjects defined in RFC 4874. 0 indicates that the attribute specified must be excluded. 1 indicates that the attribute specified should be avoided.

Type. A new subobject type is introduced; the subobject type is to be defined by IANA (suggested value: 36).

Length. The length contains the total length of the subobject in bytes, including the type and length fields. The length is always 24.

Attribute Flags. The Attribute Flags are used to communicate desirable attributes of the LSP being signaled (In the following, the term LSP2 is used to reference the LSP being signaled; please refer to Section 2.1 for definition of LSP2). The following flags are defined. None, all or multiple attribute flags may be set within the same subobject.

0×01=LSP ID to be ignored. This flag is used to indicate tunnel level exclusion.

Specifically, this flag is used to indicate that the lsp-id field of the subobject is to be ignored and the exclusion applies to any LSP matching the rest of the supplied FEC. In other words, if this flag is set, the processing node must calculate a route based on exclusions from the routes of all known LSPs matching the tunnel-id, source, destination and extended tunnel-id specified in the subobject. When this flag is not set, the lsp-id is not ignored and the exclusion applies only to the specified LSP (i.e., LSP level exclusion). In other words, when this flag is not set, route exclusions must respect the specified LSP (i.e. the isp-id, the tunnel-id, source, destination and extended tunnel-id specified needs to be respected during exclusion).

0×02=Destination node exception. This flag is used to indicate that the destination node may be shared even when sharing of the said node violates the exclusion flags. When this flag is not set, the exclusion flags should also be respected for the destination node.

0×04=Processing node exception. This flag is used to indicate that the processing node may be shared even when sharing of the said node violates the exclusion flags. When this flag is not set, the exclusion flags should also be respected for the processing node.

0×08=Penultimate node exception. This flag is used to indicate that the penultimate node may be shared even when sharing of the said node violates the exclusion flags. When this flag is not set, the exclusion flags should also be respected for the penultimate node.

Exclusion-Flags. The Exclusion-Flags are used to communicate desirable types of exclusion. The following flags are defined.

0×01=SRLG exclusion. This flag is used to indicate that the route of the LSP being signaled is requested to be SRLG diverse from the route of the LSP or tunnel specified by the LSP subobject.

0×02=Node exclusion. This flag is used to indicate that the route of the LSP being signaled is requested to be node diverse from the route of the LSP or tunnel specified by the LSP subobject. The node exclusion is subobject to the setting of the “Processing node exception”, the “Penultimate node exception” and the “Destination node exception” Attribute Flags.

0×04=Link exclusion. This flag is used to indicate that the route of the LSP being signaled is requested to be link diverse from the route of the LSP or tunnel specified by the LSP subobject.

The remaining fields are as defined in RFC 3209.

XRO processing as described in RFC 4874 is unchanged. If the node is the destination for the LSP being signaled, it should not process a LSP XRO subobject.

If the L-flag is not set, the processing node follows the following procedure:

The processing node must ensure that any route calculated for the signaled LSP (LSP2) respects the requested exclusion flags with respect to the route traversed by the LSP(s) referenced by the LSP subobject (LSP1/TUNNEL1), including local resources.

If the processing node fails to find a route that meets the requested constraint, the processing node should return a PathErr with the error code “Routing Problem” and error value “Route blocked by Exclude Route”.

If the route of the LSP or tunnel (LSP1/TUNNEL1) referenced in the LSP subobject is unknown to the processing node, the processing node should ignore the LSP subobject in XRO and should proceed with the signaling request (for LSP2). However, in this case, after sending Resv for LSP2, the processing node should return a PathErr with the error code “Notify Error (25)” and error value “Route to XRO LSP unknown (value: TBA)” for LSP2.

If latter, the route of the LSP or tunnel (LSP1/TUNNEL1) referenced in the LSP subobject becomes known (e.g. when LSP1 is signaled) or the TUNNEL1 is re-optimized to a different route, such that the requested exclusion/diversity constraints are no longer satisfied and a path that can satisfy the requested constraints exists, the node calculating or expanding the path should send a PathErr message for LSP2 with the error code “Notify Error (25)” and error value “Preferable path exists”. An ingress node receiving this error code/value combination may try to reoptimize the LSP2 to the new preferred path.

Route computation for the LSP or tunnel (LSP1/TUNNEL1) referenced in the LSP subobject for new setup or for re-optimization LSP should be performed to avoid a situation where the requested exclusion/diversity constraints are no longer satisfied and a path that can satisfy the requested constraints does not exist. However, if such situation arises the node that computed or expanded the route for LSP2 should send a PathErr message for LSP2 with the error code “Routing Problem” and error value “Route blocked by Exclude Route”.

If the L-flag is set, the processing node follows the following procedure:

The processing node should respect the requested exclusion flags with respect to the route traversed by the referenced LSP(s) (LSP1/TUNNEL1) as far as possible.

If the processing node fails to find a route that meets the requested constraint, it should proceed with a suitable route that best meets the constraint, but after completion of signaling setup, it should return a PathErr code “Notify Error (25)” and error value “Failed to respect Exclude Route (value: TBA)” to the ingress node.

If the route of the LSP or tunnel (LSP1/TUNNEL1) referenced in the LSP subobject is unknown to the processing node, the processing node should ignore the LSP subobject in XRO and should proceed with the signaling request (for LSP2). However, in this case, after sending Resv for LSP2, the processing node should return a PathErr with the error code “Notify Error (25)” and error value “Route to XRO LSP unknown (value: TBA)” for LSP2.

If latter, the route of the LSP or tunnel (LSP1/TUNNEL1) referenced in the LSP subobject becomes known (e.g. when LSP1 is signaled) or the TUNNEL1 is re-optimized to a different route, such that the requested exclusion/diversity constraints are no longer satisfied and a path that can satisfy the requested constraints exists, the node calculating or expanding the path should send a PathErr message for LSP2 with the error code “Notify Error (25)” and error value “Preferable path exists”. An ingress node receiving this error code/value combination may try to reoptimize the LSP2 to the new preferred path.

Route computation for the LSP or tunnel (LSP1/TUNNEL1) referenced in the LSP subobject for new setup or for re-optimization LSP should be performed to avoid a situation where the requested exclusion/diversity constraints are no longer satisfied and a path that can satisfy the requested constraints does not exist. However, if such situation arises, the node that computed or expanded the route for LSP2 should send a PathErr message for LSP2 with the error code “Notify Error (25)” and error value “Failed to respect Exclude Route (value: TBA)”.

The following rules apply equally to L=0 and L=1 case:

XRO object may contain multiple LSP subobjects. In which case, the processing node A node receiving a Path message carrying an XRO may reject the message if the XRO is too large or complicated for the local implementation or the rules of local policy, as per the roles of XRO defined in RFC 4874. In this case, the node must send a PathErr message with the error code “Routing Error” and error value “XRO Too Complex”. An ingress node receiving this error code/value combination may reduce the complexity of the XRO or route around the node that rejected the XRO.

An ingress node receiving PathErr with the error code “Notify Error (25)” and error values “Route to XRO LSP unknown (value: TBA)” or “Failed to respect Exclude Route (value: TBA)” may not take any action other than simply logging these notifications.

Note that LSP1 may be signaled with LSP subobject pointing to CircuitID2 and LSP2 may be signaled with LSP subobject pointing to CircuitID1. The above-mentioned processing rules cover this case, as well.

RFC 4874 defines an ERO subobject called Explicit Exclusion Route Subobject (EXRS). An EXRS is used to identify abstract nodes or resources that must not or should not be used on the path between two inclusive abstract nodes or resources in the explicit route. An EXRS contains one or more subobjects of its own, called EXRS subobjects.

An EXRS may include IPv4 P2P LSP subobject. One embodiment of an LSP subobject in EXRS 710 is illustrated in FIG. 7B. The meaning of respective fields in EXRS header is as defined in RFC 4874. Similarly, the meaning of respective fields in IPv4 P2P LSP subobject is as defined earlier in this section. This is with the exceptions that:
Processing node exception applies to the node processing the ERO.
If L bit in the ERO header is not set (ERO.L=0), the IPv4 P2P LSP subobject is processed against the LSPs for which the processing node is ingress, egress or a transit node.
Penultimate node exception applies to the penultimate node of the loose hop. This flag is only processed if EXRS.L bit is set, i.e., in the loose ERO hop case.
Destination node exception applies to the abstract node to which the route is expanded. This flag is only processed if EXRS.L bit is set, i.e., in the loose ERO hop case.
   Processing rules for the EXRS object are same as processing rules as described in RFC 4874. When the EXRS contains one or more LSP subobject(s), processing rule specified in Section 2.3 applies to the node processing the ERO with EXRS subobject.

In view of the many possible embodiments to which the principles of the disclosure may be applied, it will be appreciated that the embodiments and aspects thereof described herein with respect to the drawings/figures are only illustrative and should not be taken as limiting the scope of the disclosure. For example, and as would be apparent to one skilled in the art, many of the process block operations can be re-ordered to be performed before, after, or substantially concurrent with other operations. Also, many different forms of data structures could be used in various embodiments. The disclosure as described herein contemplates all such embodiments as may come within the scope of the following claims and equivalents thereof.

What is claimed is:

1. A method, comprising:
signaling between a client-layer network and a server-layer network with independent control planes in a multilayer network regarding a server-layer communications service, having server-layer characteristics including one or more particular server-layer characteristics, within the server-layer network for use in communicatively coupling at least two devices of the client-layer network.

2. The method of claim 1, wherein said signaling is in regards to establishing the server-layer communications service, and said signaling includes said one or more particular server-layer characteristics specified by the client-layer network that the server-layer network is to provide.

3. The method of claim 2, comprising: establishing by the server-layer network the server-layer communications service that has said one or more particular server-layer characteristics.

4. The method of claim 2, wherein said one or more particular server-layer characteristics include an objective function.

5. The method of claim 2, wherein said one or more particular server-layer characteristics include a latency, latency variation, packet loss, or bandwidth requirement.

6. The method of claim 2, wherein said one or more particular server-layer characteristics include one or more Shared Risk Link Groups (SRLGs) to be avoided or included.

7. The method of claim 2, wherein said one or more particular server-layer characteristics include one or more inclusion or exclusion routes.

8. The method of claim 2, wherein said one or more particular server-layer characteristics include a maximum setup time.

9. The method of claim 2, wherein said one or more particular server-layer characteristics include a label or set of labels, a type of switching to be used, or one or more Autonomous Systems.

10. The method of claim 1, wherein the server-layer communications service is established and communicatively coupling said at least two devices of the client-layer network; and wherein said signaling is in regards to communicating from the server-layer network to the client-layer network said one or more particular server-layer characteristics.

11. The method of claim 10, wherein said one or more particular server-layer characteristics include a latency in the server-layer network.

12. The method of claim 10, wherein said one or more particular server-layer characteristics include a figure of merit.

13. The method of claim 10, wherein said one or more particular server-layer characteristics include a cost within the server-layer network.

14. The method of claim 10, wherein said one or more particular server-layer characteristics include an estimated setup time of the server-layer communications service or to restore the server-layer communications service.

15. The method of claim 1, wherein each of said at least two devices of the client-layer network is a Layer-3 or Layer-2 packet switching device.

16. The method of claim 13, wherein the server-layer network is an optical network.

17. The method of claim 1, wherein the server-layer network is an optical network.

18. The method of claim 1, wherein said signaling between the client-layer network and the server-layer network includes sending extended Resource Reservation Protocol (RSVP) messages.

19. A packet switching device, comprising:
one or more processing elements;
memory;
a plurality of interfaces configured to send and receive packets within a client-layer network of a multilayer network;
an optical interface configured to communicate with an optical node of an optical server-layer network of the multilayer network; and
one or more packet switching mechanisms configured to switch packets among the plurality of interfaces;
wherein said one or more processing elements are configured to perform operations, including: requesting, using an extension of Resource Reservation Protocol (RSVP), an optical communications path through the optical node and one or more other nodes of the optical server-layer network between the packet switching device and a second packet switching device in the client-layer network, which includes specifying one or more particular server-layer characteristics required of the optical communications path.

20. An optical node, comprising:
one or more processing elements;
memory;
an optical interface configured to send and receive optical frames within an optical server-layer network of a multilayer network providing communications paths between a first and a second packet switching devices of a client-layer network of the multilayer network; and
a user network optical interface configured to communicate data and signaling information with the first packet switching;
wherein said one or more processing elements are configured to perform operations, including: signaling, using an extension of Resource Reservation Protocol (RSVP), one or more particular server-layer characteristics of an existing optical communications path through the optical node and one or more other nodes of the optical server-layer network between the first and the second packet switching devices.
